(19) United States
(12) Patent Application Publication
(10) Pub. No.: US 2024/0311656 A1
(43) Pub. Date: Sep. 19, 2024

(54) Scalable and Resource-Efficient Knowledge-Graph Completion

(71) Applicant: Microsoft Technology Licensing, LLC, Redmond, WA (US)

(72) Inventors: Xiaodong LIU, Woodinville, WA (US); Jian JIAO, Bellevue, WA (US); Hao CHENG, Kirkland, WA (US); Sanxing CHEN, Durham, NC (US); Jianfeng GAO, Woodinville, WA (US)

(73) Assignee: Microsoft Technology Licensing, LLC, Redmond, WA (US)

(21) Appl. No.: 18/122,691

(22) Filed: Mar. 16, 2023

(51) Int. Cl. G06N 5/022

(52) U.S. Cl. CPC G06N 5/022

(57) ABSTRACT

A technique performs the task of knowledge-graph completion in a manner that is both scalable and resource efficient. In some implementations, the technique identifies a source entity having a source-target relation that connects the source entity to a yet-to-be-determined target entity. The technique also identifies a source-entity data item that provides a passage of source-entity text pertaining to the source entity. The technique uses a machine-trained encoder model to map the source-entity data item to source-entity encoded information. The technique then predicts an identity of the target entity based on the source-entity encoded information, and based on predicate encoded information that encodes the source-target relation. In some implementations, the technique also predicts the target entity based on a consideration of one or more neighboring entities that are connected to the source entity and their respective source-to-neighbor relations. The technique further allows transfer of knowledge across knowledge-graph training stages.

### BACKGROUND

A knowledge graph expresses facts as respective triplets. An illustrative triplet specifies that a subject entity is related to an object entity by a specified predicate. The knowledge graph represents the two entities using two respective nodes, and represents the predicate as an edge that connects the two nodes. An example of a triplet is “Bill Gates” (the subject entity), “Microsoft” (the object entity), and “founded” (the predicate), which expresses the fact that Bill Gates founded Microsoft Corporation. Numerous services rely on knowledge graphs, including search engines, question-answering services, dialog engines, various natural language processing tools, and so on.

However, a knowledge graph is often incomplete, meaning that it does not encode all of the facts that are of interest in a particular domain. To address this situation, the industry has proposed the use of various types of knowledge-graph completion engines. In a typical manner of operation, a completion engine receives two data items of an incomplete triplet. The completion engine attempts to predict the identity of the unknown member of the incomplete triplet. For instance, given a subject entity and a predicate, the completion engine attempts to predict the identity of the object entity.

There is room for improvement in existing completion engines. For instance, for reasons described herein, some completion engines require a large amount of memory to run. In addition, or alternatively, some completion engines are not scalable. This means these engines are trained for use in a particular knowledge domain having particular domain-specific entities and relations, and cannot be effectively used in other domains having other domain-specific entities and relations.

### SUMMARY

A technique is described herein that performs the task of knowledge-graph completion. In some implementations, the technique involves identifying a source entity having a source-target relation that connects the source entity to a yet-to-be-determined target entity. The technique also identifies a source-entity data item that provides a passage of source-entity text pertaining to the source entity. The technique uses a machine-trained encoder model to map a language-based representation of the source-entity data item to source-entity encoded information. The technique then predicts an identity of the target entity based on the source-entity encoded information, and based on predicate encoded information that encodes the source-target relation.

According to some implementations, the technique also predicts the target entity based on a consideration of one or more neighboring entities that are connected to the source entity, and the relations that connect the neighboring entities to the source entity. This added information generally represents the neighborhood-related context of the source entity in the knowledge graph.

In some implementations, the technique predicts the identity of the target entity in two stages. The first stage encodes all entities that are involved in a particular knowledge-graph completion task. The second stage refines output information generated by the first stage, based on identified relations among the entities, including neighbor relations.

The technique makes efficient use of memory compared to other techniques. The technique is also scalable for a number of reasons. First, the technique's parameter space does not linearly increase with the number of entities in the knowledge graph, as is the case for some other approaches. Second, the knowledge that the technique acquires in the course of operating on a first knowledge graph is transferable to learning applied to a second knowledge graph. This is true even if the second knowledge graph includes entities and/or relations not found in the first knowledge graph (and/or vice versa). Third, the technique enables predictions to be made about entities that are not represented in the training examples that were used to train the technique.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a computing system for training and using a completion engine.

FIG. 2 shows a two-stage machine-trained encoder model used by the completion engine of FIG. 1.

FIG. 3 shows one implementation of an input encoder for use in an entity-encoding system, which is one component of the machine-trained encoder model of FIG. 2.

FIG. 4 shows one implementation of an input encoder for use in a context-encoding system, which is another component of the machine-trained encoder model of FIG. 2.

FIG. 5 shows a transformer-based machine-trained model. In some implementations, each stage of the two-stage machine-trained encoder model shown in FIG. 2 makes use of the functionality of FIG. 5.

FIG. 6 shows one implementation of a training system for training the machine-trained encoder model used by the completion engine of FIG. 1.

FIG. 7 shows the use of the training system of FIG. 6 to successively refine a set of weights, with reference to two or more different knowledge graphs.

FIG. 8 shows a process that represents one manner of operation of the computing system of FIG. 1.

FIGS. 9 and 10 show a process that represents another manner of operation of the computing system of FIG. 1.

FIG. 11 shows computing equipment that, in some implementations, is used to implement the computing system of FIG. 1.

FIG. 12 shows an illustrative type of computing system that, in some implementations, is used to implement any aspect of the features shown in the foregoing drawings.

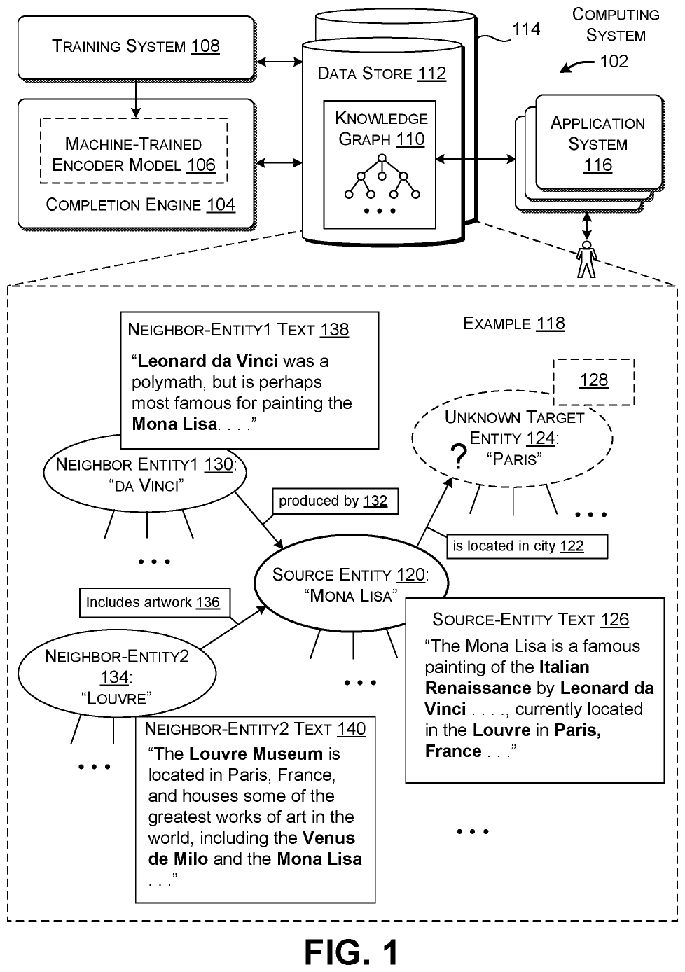

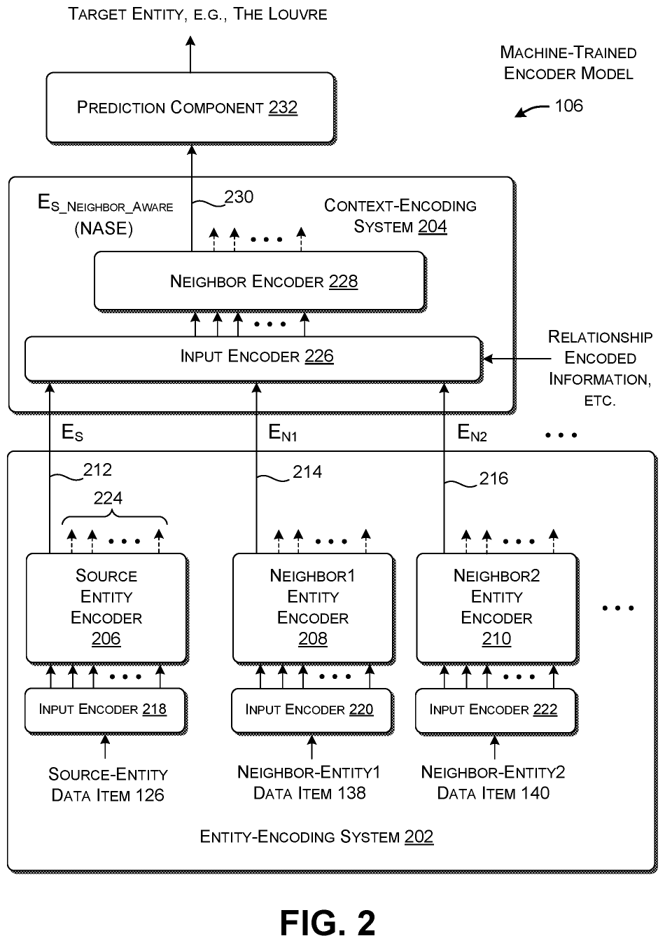

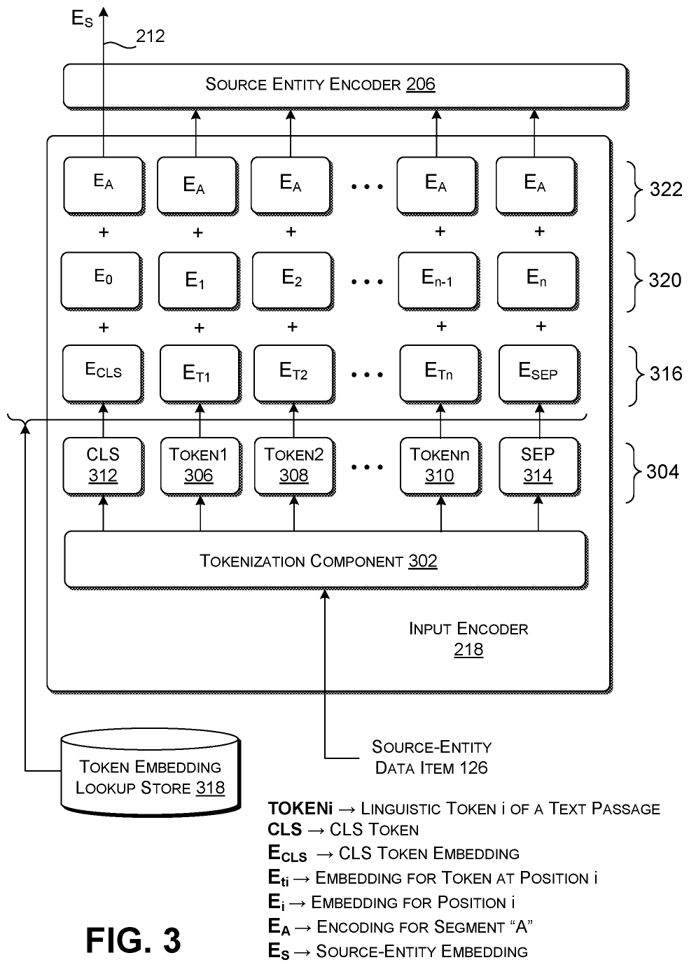

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

FIG. 1 shows a computing system 102 that uses a completion engine 104 to perform the task of knowledge-graph completion. As stated above, the task of knowledge-graph completion involves predicting an identity of an unknown item in a knowledge graph triplet. This explanation will specifically focus on the case in which completion engine 104 predicts an unknown target entity, given a source entity and a predicate. The source entity corresponds to either a subject entity or an object entity. The predicate describes a relation between the subject entity and the object entity. For example, consider the fact “John sold his car.” “John” is the subject entity, “car” is the subject entity, and “sold” is the predicate. If the subject object “car” is missing, the completion engine 104 will attempt to determine the identity of this entity.

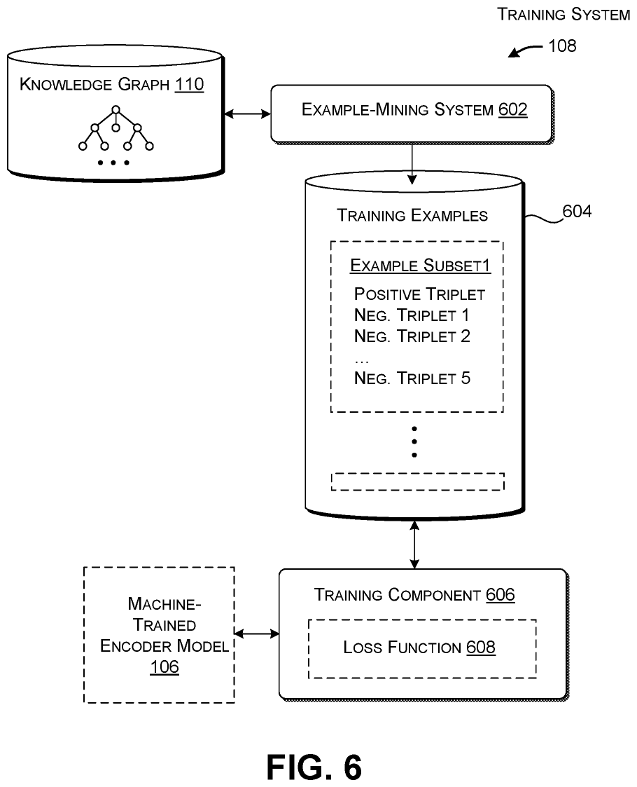

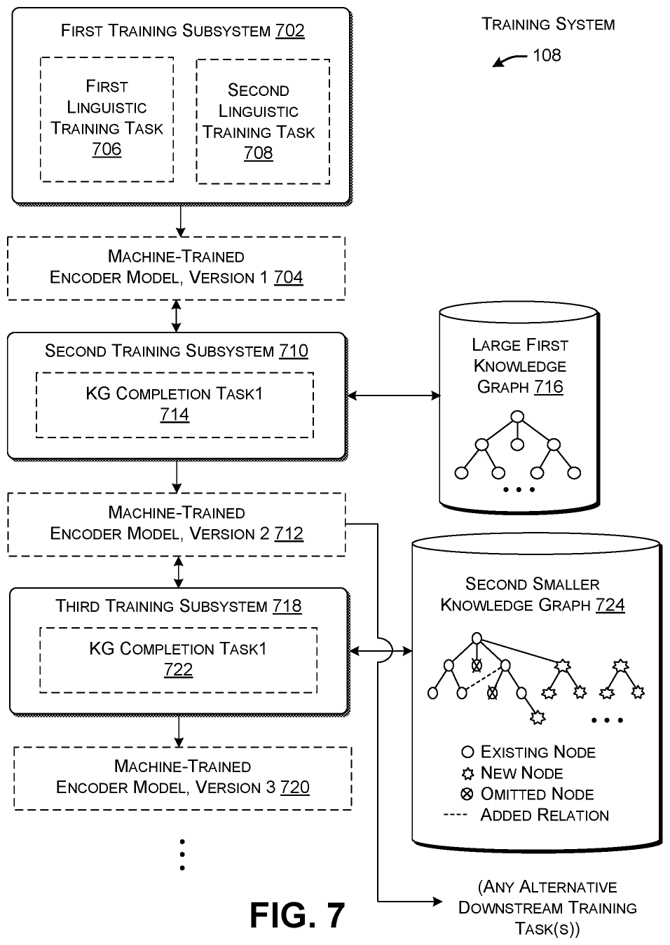

The completion engine 104 relies on a machine-trained encoder model 106 to perform its task. A training system 108 trains the weights of the machine-trained encoder model 106. The following description explains the operation of the completion engine 104 with respect to FIGS. 2-5. The description explains the operation of the training system 108 with respect to FIGS. 6 and 7.

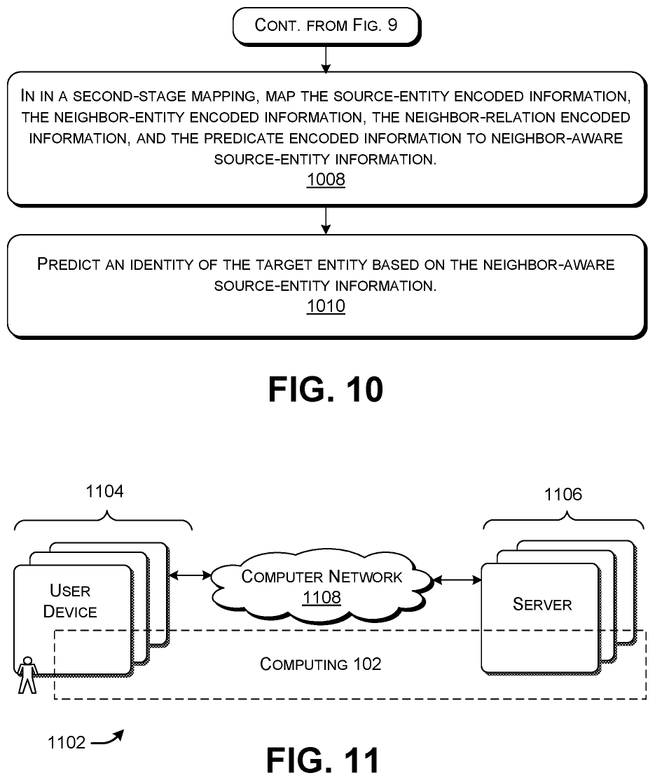

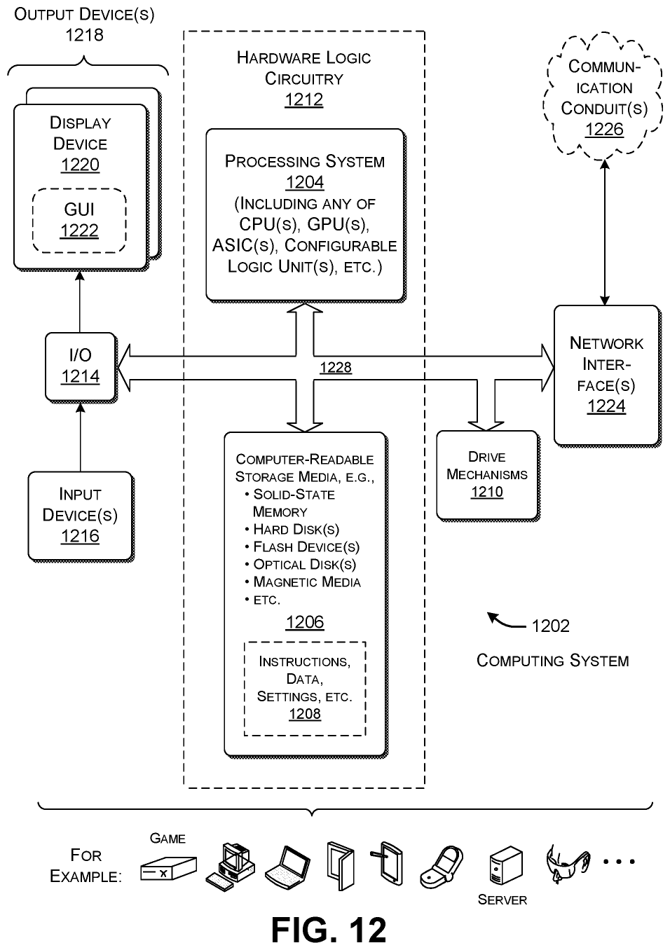

By way of terminology, as used herein, a “machine-trained model” refers to computer-implemented logic for executing a task using machine-trained weights that are produced in a training operation. A “weight” refers to a parameter value that is iteratively produced by a training operation. In some contexts, terms such as “component,” “module,” “engine,” and “tool” refer to parts of computer-based technology that perform respective functions. FIGS. 11 and 12, described below, provide examples of illustrative computing equipment for performing these functions

The completion engine 104 and the training system 108 operate on a knowledge graph 110 provided in a data store 112. The knowledge graph 110 expresses a set of facts. Each fact includes a triplet including a source entity, a predicate, and an object entity. One or more other data stores (e.g., data store 114) provide text-based information regarding any of the items provided in the knowledge graph 110. For example, assume that one of the entities in the knowledge graph 110 identifies the founder of Microsoft Corporation, Bill Gates. The data store 114 provides one or more items that provide a text-based description of this individual. The text-based information in the data store 114 takes different forms in different environments. In some implementations, the information includes any of: encyclopedia-related entries, dictionary-related entries, news article-related entries, messages of any type(s), behavioral evidence (e.g., user clicks in a browser application), search results, etc.

In one scenario, the completion engine 104 detects a new target entity that was not previously represented by the knowledge graph 110. In response to this discovery, the completion engine 104 may add a node associated with the new target entity to the knowledge graph 110, and one or more edges that connect the new target entity to existing nodes in the knowledge graph 110. In other cases, the completion engine 104 discovers a new relation among existing nodes (and corresponding entities) in the knowledge graph 110. In response to this discovery, the completion engine 104 adds the new edge to the knowledge graph 110. The prediction of new entities is referred to as “induction,” while the discovery of new facts among existing entities is “transduction.” In other cases, to be described below, the completion engine 104 performs completion for the case in which neither the source entity nor the target entity are represented by the knowledge graph 110 in an initial state. Here, the completion engine 104 can add nodes associated with both of these entities to the knowledge graph 110.

In a training scenario, the completion engine 104 already includes a node associated with a target entity, which establishes ground-truth identity information. The training system 108 instructs the completion engine 104 to predict the identity of a target entity. The training system 108 compares the completion engine's prediction with the ground-truth identity information, and uses this information to update the weights of the machine-trained encoder model 106.

In some implementations, the completion engine 104 uses a two-stage approach to determine the identity of an unknown target entity. In a first stage, the completion engine 104 encodes information regarding all of the entities that will play a role in the determination of the identity of a target entity. These entities include a source entity and any neighboring entities that are connected to the source entity in the knowledge graph 110. The first stage yields one or more instances of entity embedding information. In a second stage, the completion engine 104 combines the entity embedding information together with context information that describes the relationships between the entities processed in the first stage. The completion engine 104 then maps this combined information to an instance of context-aware embedding information. A prediction component then uses the context-aware embedding information to determine the identity of the target entity.

A representative application system 116 interacts with the knowledge graph 110 to provide various services. The application system 116 is one of many possible application systems. In some environments, the application system 116 is a recommendation engine that uses the knowledge graph 110 to provide a recommendation to a user. For example, assume that the user expresses interest in a first product. The recommendation engine consults the knowledge graph 110 to determine other products that are linked to the first product. The recommendation engine then provides output information that notifies the user of the existence of the other products. Other application systems utilize the knowledge graph 110 to provide any of a search service, an ad-serving service, a question-answering service, a dialogue (e.g., chat) service, etc. Other application systems rely on the knowledge graph 110 to perform various natural language processing (NLP) tasks. Note that one or more application systems may interact with the completion engine 104, in addition to the knowledge graph 110, e.g., by using the completion engine 104 to predict the unknown member of an incomplete triplet.

The operation of the completion engine 104 will be set forth below in greater detail with respect to FIGS. 2-4. To help frame that explanation, FIG. 1 shows an example 118 of a particular problem involving an incomplete triplet. The incomplete triplet includes a given source entity 120 and a given source-target relation 122, also known as the predicate. Assume that the source entity 120 corresponds to the “Mona Lisa” and the source-target relation 122 corresponds to “is located in city of.” At the outset, a target entity 124 is unknown. Assume that the completion engine 104 determines that the target entity 124 corresponds to “Paris.” The source entity 120 is associated with a source-entity data item 126, and the target entity 124 is associated with a target-entity data item 128.

The completion engine 104 takes into consideration context information when predicting the identity of the target entity 124. The context information specifically indicates that a first neighbor entity 130 is connected to the source entity 120 via a first neighbor relation 132, and a second neighbor entity 134 is connected to the source entity 120 via second neighbor relation 136. This is a simplified example; in other cases, many more neighbor entities are connected to the source entity 120. A first neighbor-entity data item 138 is associated with the first neighbor entity 130, and a second neighbor-entity data item 140 is associated with the second neighbor entity 134.

FIG. 2 shows one implementation of the machine-trained encoder model 106 (“encoder model” for brevity). The encoder model 106 operates in two stages using an entity-encoding system 202 and a context-encoding system 204, respectively. The entity-encoding system 202 performs the role of generating instances of encoded information for all of the entities involved in a particular knowledge-graph completion task. The context-encoding system 204 modifies the encoded information generated by the entity-encoding system 202, based on information regarding relations among the entities processed in the entity-encoding system 102. To facilitate explanation, the encoder model 106 will be set forth below in the context of the illustrative example 118 shown in FIG. 1.

The entity-encoding system 202 shows the use plural entity encoders (206, 208, 210, . . . ). In practice, the encoder model 106 can implement these entity encoders (206, 208, 210, . . . ) using plural instances of logic (e.g., provided by plural processing units that operate in parallel). Alternatively, or in addition, the encoder model 106 implements the entity encoders (206, 208, 210, . . . ) using a single instance of logic that is repeatedly called.

Assume that the first entity encoder 206 (referred to as the “source entity encoder”) maps the source-entity data item 126 to source-entity encoded information 212 (E_{S}), the second entity encoder 208 (referred to as the “neighbor1 entity encoder”) maps the first neighbor-entity data item 138 to a first instance of neighbor-entity encoded information 214 (E_{N1}), and the third entity encoder 210 (referred to as the “neighbor2 entity encoder”) maps the second neighbor-entity data item 140 to a second instance of neighbor-entity encoded information 216 (E_{N2}). Each instance of encoded information corresponds to a distributed vector having a prescribed dimension. A distributed vector is a typically dense vector that presents information in a vector space in a manner that is distributed over its dimensions, as opposed, for example, to a sparse one-hot vector that allocates a distinct concept to each of its dimensions.

An input encoder 218 maps the source-entity data item 126 to input information, which, in turn, is fed to the source entity encoder 206. As will be described in greater detailed below (in connection with FIG. 3), the input encoder 218 tokenizes the words in the source-entity data item 126 into a string of tokens of a natural language. The input encoder 218 then converts the tokens to token embeddings, each of which corresponds to a distributed vector. The entity-encoding system 202 includes input encoders (220, 222) that perform the same functions with respect to the neighbor1 entity encoder 208 and the neighbor2 entity encoder 210, respectively.

The source entity encoder 206 outputs a stream of output embeddings, respectively corresponding to the input token embeddings. Each output embedding (Tᵢ) is a distributed vector. The source-entity encoded information 212 (E_{S}) is one such output embedding. Other output embeddings 224 play a role in the training of the encoder model 106, but are ignored in the context of the operations illustrated in FIG. 2. The neighbor1 entity encoder 208 and the neighbor2 entity encoder 210 likewise each produce a set of output embeddings.

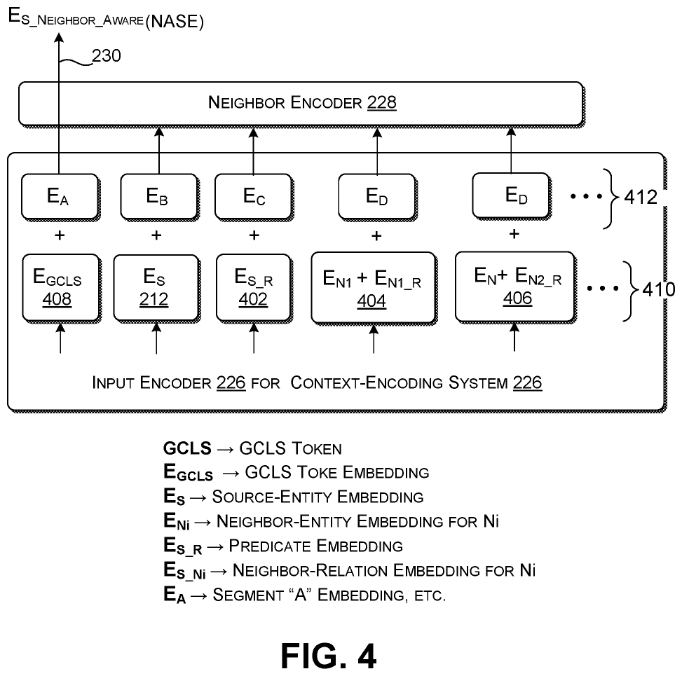

The context-encoding system 204 includes its own input encoder 226 for assembling an instance of input information to be processed by the context-encoding system 204. As will be described more fully in the context of FIG. 4 below, the input information includes: the entity embeddings (E_{S}, E_{N1}, E_{N2}) produced by the entity-encoding system 202; predicate encoded information (E_{S_R}) that represents an encoded version of the source-target relation 122, first neighbor-relation encoded information (E_{N1_R}) that represents an encoded version of the first neighbor relation 132, and second neighbor-relation encoded information (E_{N2_R}) that represents an encoded version of the second neighbor relation 136.

A neighbor encoder 228 maps the input information provided by the input encoder 226 to a sequence of output embeddings, including neighbor-aware source-entity information 230 (E_{S_Neighbor_Aware}) (“NASE” information 230 for brevity). The NASE information 230 is a distributed vector that expresses the meaning of the source entity 120 and its source-target relation 122. The NASE information 230 is said be “neighbor aware” because it also takes into account the meaning of the neighbor entities (130, 134) that are connected to the source entity 120, and the neighbor relations (132, 136) that connect the neighbor entities (130, 134) to the source entity 120. Moore generally stated, the NASE information 230 takes account for the neighborhood of the knowledge graph 110 that include the source entity 120.

A prediction component 232 determines the identity of the target entity based on the NASE information 230. In one technique, assume that the prediction component 232 has access to a lookup table or the like which stores a plurality of target-entity vectors associated with entity names (e.g., “Paris” for the target entity 124). Assume that, in a preliminary operation, a background system (not shown) has previously produced the target-entity vectors by mapping target-entity data items to respective instances of target-entity encoded information, corresponding to the target-entity vectors. For instance, in some implementations, the background system produces the target-entity vectors using the same type of entity encoder provided by the entity-encoding system 202. The prediction component 232 compares the NASE information 230 with each candidate target-entity vector, and selects the target-entity vector that is closest to the NASE information 230.

In some implementations, the prediction component 232 uses a cosine similarity metric to assess the relation between two vectors, but the prediction component can use any other distance metric to compare two vectors (a dot product metric, a Manhattan distance metric, etc.). Further, the prediction component 232 can use any technique to explore the space of candidate target-entity vectors, such as an exhaustive search of all candidate target-entity vectors, the approximate nearest neighbor (ANN) technique, and so on.

Overall, the encoder model 106 makes more efficient use of system resources compared to other approaches. For frame of reference, consider an alternative approach that assigns unique IDs to the entities in the knowledge graph, and then treats the unique IDs as the atomic unit of entity representation. Some of these systems also use a lookup table that stores embeddings associated with the unique IDs. The memory that such a system uses increases linearly with the size of the knowledge graph. This also means that such a system becomes increasingly intractable with the growth of the knowledge graph. In contrast, the encoder model 106 described herein treats linguistic tokens as the smallest units of representation. This factor allows the encoder model 106 to operate using a smaller parameter space compared to the alternative technique described above, and hence, consume less memory than the alternative technique.

The encoder model 106 is also scalable for a number of reasons. First, the encoder model's parameter space does not linearly increase with the number of entities in the knowledge graph, as is the case for the above-described alternative approach. Second, the knowledge that the computing system 102 shown in FIG. 1 acquires in the course of operating on a first knowledge graph is transferable to learning applied to a second knowledge graph (and any number of subsequent knowledge graphs). This is true even if the second knowledge graph includes entities and/or relations not found in the first knowledge graph (and/or vice versa). Third, the computing system 102 enables predictions to be made about entities that are not represented in the training examples it has previously processed.

As a point of clarification, the operation of the completion engine 104 was described above for the illustrative case in which the knowledge graph 110 includes nodes for all entities involved in the analysis, with the exception of the target entity 124, which is unknown at the outset. But the completion engine 104 can operate on entities not yet represented by an existing knowledge graph, providing that the above-described input information that is fed to the completion engine 104 is available; this input information incudes text pertaining to the entities that can be processed by the entity encoders of the entity-encoding system 202. This also means that the completion engine 104 can add plural new nodes to an existing knowledge graph as a result of its analysis.

FIG. 3 shows one implementation of the input encoder 218 and the source entity encoder 206 introduced in FIG. 2. These components map the source-entity data item 126 to the source-entity encoded information 212 (E_{S}). Although not shown, the other components of the entity-encoding system 202, for processing neighbor-entity text, have the same construction and perform the same operations as the input encoder 218 and the source entity encoder 206.

A tokenization component 302 breaks the source-entity data item 126 into a sequence of linguistic tokens 304, including tokens (306, 308, . . . 310), which are concatenated together. Different implementations perform this operation in different respective ways. In some examples, the tokenization component 302 allocates a token to each complete word in the source-entity data item 126. In other examples, the tokenization component 302 creates tokens for the respective character n-grams that compose the source-entity data item 126. A character n-gram is a sequence of n characters in a word. For instance, with n=3, the word “Gates” includes the n-grams “#Ga,” “Gat,” “ates,” “tes,” and “es #,” where “#” is an added demarcation token.

In other cases, the tokenization component 302 uses any type of algorithmic approach to generate linguistic tokens, including any of: byte pair encoding (BPE); the WordPiece algorithm; the SentencePiece algorithm, etc. Background information regarding the WordPiece algorithm can be found in Wu, et al., “Google's Neural Machine Translation System: Bridging the Gap between Human and Machine Translation,” in Cornell University's arXiv repository, arXiv: 1609.08144v2 [cs.CL], Oct. 8, 2016, 23 pages. Background information regarding BPE technique can be found in Sennrich, et al., “Neural Machine Translation of Rare Words with Subword Units,” in Cornell University's ar Xiv repository, arXiv: 1508.07909v5 [cs.CL], Jun. 10, 2016, 11 pages. Background information regarding the SentencePiece algorithm is provided in Kudo, et al., “SentencePiece: A simple and language independent subword tokenizer and detokenizer for Neural Text Processing,” available at Proceedings of the 2018 Conference on Empirical Methods in Natural Language Processing (System Demonstrations), October 2018, pp. 66-71. In general, some of these approaches attempt to break up text into components based on the frequency at which combinations of characters appear in a natural language.

In some implementations, the tokenization component 302 adds a special classification (“CLS”) token 312 to the beginning of the sequence of linguistic tokens 304. The tokenization component 302 adds a terminal “SEP” token 314 to the end of the sequence of linguistic tokens 304. Other implementations can omit the use of these special characters, or use some other types of special characters. The meaning of any special character is established in the course of a training operation, e.g., by virtue of the role it plays in the overall encoder model 106.

Next, the input encoder 218 replaces the sequence of tokens with a sequence of token embeddings 316. In some implementations, the input encoder 218 performs this task by consulting a lookup store 318 to find a machine-trained token embedding associated with each linguistic token in the sequence of linguistic tokens 304, wherein that token embedding is in the form of a distributed vector. In other cases, the input encoder 218 uses a machine-trained neural network of any type (e.g., a feed-forward neural network of any type) to map a one-hot vector representation of a linguistic token to a token embedding in the form of a distributed vector. Note that, whatever tokenization technique is used, there is a finite number of linguistic tokens associated with a natural language. This means that there is likewise a finite number of token embeddings to select from in composing the sequence of token embeddings 316. The encoder model 106 itself is predicated on the use of these linguistic token embeddings, rather than treating entities as the atomic units of representation.

The input encoder 218 then adds two vectors to each token embedding, to produce a sequence of final token embeddings for processing by the source entity encoder 206. For example, the input encoder 218 adds position information 320 and segment information 322 to each token embedding in the sequence of token embeddings 316. A particular element of the position information 320 describes the position of a particular linguistic token in the sequence of linguistic tokens 304. A particular element of the segment information 322 identifies the segment of input information in the sequence of linguistic tokens 304 from which a particular linguistic token originates. Here, all linguistic tokens are considered to originate from the same segment “A.”

In some implementations, the source entity encoder 206 maps the CLS token 312 to the source-entity encoded information 212 (E_{S}). As noted, the source entity encoder 206 produces other output embeddings 224 corresponding to the other linguistic tokens in the sequence of linguistic tokens 304, but these output embeddings 224 do not play a part in generating the output that is fed to the context-encoding system 204. Note that the source-entity encoded information 212 (E_{S}) nevertheless depends on the other linguistic tokens in the sequence of linguistic tokens 304.

FIG. 4 shows one implementation of the input encoder 226 for use in the context-encoding system 204. The input encoder 226 receives the source-entity encoded information 212 (E_{S}), the first neighbor-entity encoded information 214 (E_{N1}), and the second neighbor-entity encoded information 216 (E_{N2}) from the entity-encoding system 202. The input encoder 226 also receives predicate encoded information 402 (E_{S_R}), which corresponds to an encoded version of the source-text relation 122, first neighbor-relation encoded information (E_{N1_R}) that corresponds to an encoded version of the first neighbor relation 132, and second neighbor-relation encoded information (E_{N2_R}) that corresponds to an encoded version of the second neighbor relation 136. In some implementations, each instance of encoded relation-information is produced based on a machine-trained vector that is randomly initialized. But in other implementations, each instance of encoded relation-information is produced by encoding the text of the relation information, e.g., in a similar manner to the entity encoders.

In some implementations, the input encoder 226 adds the first-neighbor encoded information (E_{N1}) to the first neighbor-relation encoded information (E_{N1_R}), to produce a first sum 404. The input encoder 226 also adds the second-neighbor encoded information (E_{N2}) to the second neighbor-relation encoded information (E_{N2_R}), to produce a second sum 406. The input encoder 226 inserts an encoded version 408 (E_{GCLS}) of a special “GGLS” token at the beginning of the sequence of input tokens. Altogether, the input encoder 226 produces a sequence of embeddings 410, formed by concatenating E_{GCLS}, E_{S}, E_{S_R}, E_{N1}+E_{N1_R}, and E_{N2}+E_{N2_R}. In some implementation, the input encoder 226 adds encoded segment information 412 to the sequence of embeddings 410, but not embedded position information. In some implementations, the GCLS token is associated with a first segment (segment “A”), E_{S} is associated with a second segment (segment “B”), E_{S_R} is associated with a third segment (segment “C”), and E_{N1+N1_R} and E_{N2+N2_R} are each associated with a fourth segment (segment “D”). Here, the segment information adequately identifies the parts of the sequence of embeddings 410, avoiding the need for separately-specified position information. This way of structuring input information is illustrative; other implementations can structure the input information fed to the neighbor encoder 228 in other respective ways.

In some implementations, the neighbor encoder 228 maps the encoded version of the GCLS token (E_{GCLS}) to the neighbor-aware source-entity (NASE) information 230 (E_{S_Neighbor_Aware}). The neighbor encoder 228 produces other output embeddings (not shown) corresponding to the other embeddings in the sequence of embeddings 410, but these output embeddings do not play a part in generating the NASE information 230. Note that the NASE information 230 nevertheless depends on the other embeddings in the sequence of embeddings 410.

Other implementations of the encoder model 106 vary the configuration shown in FIGS. 2-4 in any way. For example, in the above-described configuration, the encoder model 106 uses the entity-encoding system 202 to only encode the entities involved in a knowledge-completion task. The encoder model 106 uses the context-encoding system 204 to consider the relations among the entities. In other implementations, the entity-encoding system 202 can, alternatively, or in addition, also take into account any of the relation information described above (e.g., pertaining to the source-target relation 122, the first neighbor relation 132, and/or the second neighbor relation 136). This approach may improve the accuracy of the results, but it also increases the complexity of the entity-encoding system 202 and the amount of resources it consumes to run.

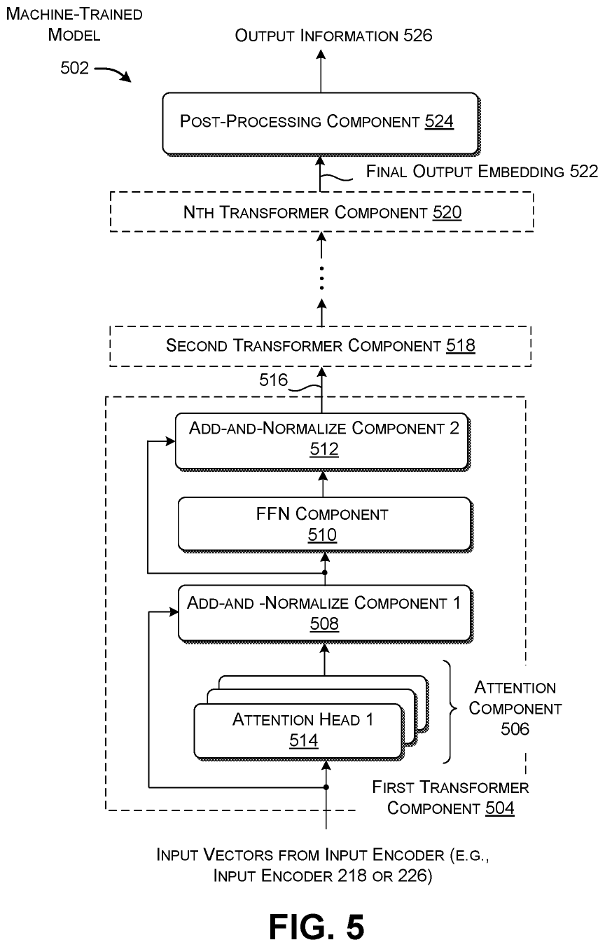

FIG. 5 shows a transformer-based machine-trained model 502 (“model” for brevity) that, in some implementation, is used to implement each entity encoder in the entity-encoding system 202, and the neighbor encoder 228 of the context-encoding system 204. The model 502 receives a sequence of input vectors produced by any input encoder of the entity-encoding system 202 (e.g., the input encoder 218), or the input encoder (e.g., the input encoder 226) of the context-encoding system 204. The model 502 processes the sequence of input vectors using a pipeline of Z transformer components, including a first transformer component 504. Each downstream transformer component operates on a sequence of input vectors produced by the preceding transformer component in the pipeline. In one implementation, Z=9, with six transformation components being used for the entity-encoding system 202, and three transformation components being used for the context-encoding system 204. In this case, the entity-related processing is more robust compared to the context-related processing.

FIG. 5 provides details regarding one way to implement the first transformer component 504. Although not specifically illustrated, other transformer components of the model 502 have the same architecture and perform the same functions as the first transformer component 504 (but are governed by separate sets of weights). In some implementations, the first transformer component 504 includes, in order, an attention component 506, a first add-and-normalize component 508, a feed-forward neural network (FFN) component 510, and a second add-and-normalize component 512.

The attention component 506 performs attention analysis using the following equation:

$$attn ( Q , K , V ) = Softmax ( \frac{{QK}^{T}}{\sqrt{d}} ) V . \qquad ( 1 )$$

The attention component 506 produces query information Q by multiplying the input vectors by a query weighting matrix W^{Q}. Similarly, the attention component 506 produces key information K and value information V by multiplying the position-supplemented embedding vectors by a key weighting matrix W^{K} and a value weighting matrix W^{V}, respectively. To execute Equation (1), the attention component 506 takes the dot product of Q with the transpose of K, and then divides the dot product by a scaling factor \sqrt{d}, to produce a scaled result The symbol d represents the dimensionality of Q and K. The attention component 506 takes the Softmax (normalized exponential function) of the scaled result, and then multiplies the result of the Softmax operation by V, to produce attention output information. More generally stated, the attention component 506 determines how much emphasis should be placed on parts of the input information when interpreting other parts of the input information. Background information regarding the general concept of attention is provided in Vaswani, et al., “Attention Is All You Need,” in 31st Conference on Neural Information Processing Systems (NIPS 2017), 2017, 11 pages.

Note that FIG. 5 shows that the attention component 506 is composed of plural attention heads, including a representative attention head 514. Each attention head performs the computations specified by Equation (1), but with respect to a particular representational subspace that is different than the subspaces of the other attention heads. To accomplish this operation, the attention heads perform the computations described above using different respective sets of query, key, and value weight matrices. Although not shown, the attention component 506 concatenates the output results of the attention component's separate attention heads, and then multiplies the results of this concatenation by another weight matrix W^{O}.

The add-and-normalize component 508 includes a residual connection that combines (e.g., sums) input information fed to the attention component 506 with the output information generated by the attention component 506. The add-and-normalize component 508 then normalizes the output information generated by of the residual connection, e.g., by normalizing values in the output information based on the mean and standard deviation of those values. The other add-and-normalize component 512 performs the same functions as the first-mentioned add-and-normalize component 508. The FFN component 510 transforms input information to output information using a feed-forward neural network having any number of layers.

The first transformer component 504 produces an output embedding 516. A series of other transformer components (518, . . . , 520) perform the same functions as the first transformer component 504, each operating on an output embedding produced by its immediately preceding transformer component. Each transformer component uses its own level-specific set of machine-trained weights. The final transformer component 520 in the model 502 produces a final output embedding 522.

A post-processing component 524 performs post-processing operations on the final output embedding 522, to produce the final output information 526. In one case, for instance, the post-processing component 524 performs a machine-trained linear transformation on the final output embedding 522, and processes the result of this transformation using a Softmax component (not shown).

Other implementation use other model architectures to implement the entity-encoding system 202 and the context-encoding system 204, instead of a transformer-based architecture or in addition to a transformer-based architecture. Examples of other model architectures include feed-forward neural networks of any type, convolutional neural networks (CNNs), recurrent neural networks (RNNs), and so on.

FIG. 6 shows one implementation of the training system 108 of FIG. 1. The training system 108 includes an example-mining system 602 for mining training examples from the knowledge graph 110 and/or from any other source(s). A data store 604 stores the training examples. A training component 606 iteratively processes the training examples, to iteratively adjust the weights of the encoder model 106.

In some implementations, the example-mining example 602 produces a positive training example by extracting an established “true” triplet from the knowledge graph 110, e.g., including a known subject entity that is connected to a known object entity via a known predicate. The example-mining example 602 produces negative counterpart examples for this positive example by corrupting the fact, e.g., by replacing the object entity with another object entity that is presumed to be incorrect. This establishes a “false” fact. To reduce the consumption of memory in processing a batch of training examples, the example-mining system 602 can, in some instances, reuse previously-calculated embeddings in constructing negative examples. For instance, the example-mining system 602 can use the same embedding for an object entity in constructing two or more negative examples.

In some examples, for each training example, the training component 606 produces predicted embedding information (e.g., the NASE information 230 (E_{S_Neighbor_Aware})). The training component 606 uses a loss function 608 to assess the extent to which the predicted NASE information differs from a result that is expected, as governed by the ground-truth result associated with a particular training example. More specifically, in some examples, the training component 606 measures loss using a cross-entropy function. The training component 606 iteratively adjust the weights of the encoder model 106 based on the assessment of the loss function 608. For instance, the training component 606 adjusts weights using stochastic gradient descent in combination with backpropagation.

FIG. 7 shows the application of the training system 108 of FIG. 1 to an environment in which model weights are successively refined. A first training subsystem 702 produce a first version 704 of the encoder model 106. The first training subsystem 702 performs this task by training the encoder model 106 on two language-modeling tasks (706, 708), independent of any consideration of the role of the encoder model 106 in a knowledge-graph completion task. In some implementations, the first training subsystem 702 processes a relatively large number of training examples, compared to later training operations performed by the training system 108.

In some examples, in the first language-modeling task 706, the first training subsystem 702 randomly masks tokens in a sequence of input tokens fed to the encoder model 106. The first training subsystem 702 assesses an extent to which it can successfully predict the identities of the masked tokens, and updates the weights of the encoder model 106 accordingly. In the second language-modeling task 708, the first training subsystem 702 feeds two concatenated sentences to the encoder model 106. The first training subsystem 702 then measures an extent to which it can successfully predict whether the second sentence properly follows the first sentence (with reference to ground-truth information that indicates whether the second sentence properly follows the first sentence), and then updates the weights of the encoder model 106 accordingly.

A second training subsystem 710 refines the weights of the first version 704 of the encoder model 104, to produce a second version 712 of the encoder model 106. The second training subsystem 710 performs this function by executing a first knowledge-graph completion task 714 in the manner specified in FIG. 6, with reference to examples mined from a first knowledge graph 716. Assume that the first knowledge graph 716 incudes a first set of entities connected by a first set of edges.

A third training subsystem 718 refines the weights of the second version 712 of the encoder model 106, to produce a third version 720 of the encoder model 106. The third training system 718 performs this function by executing a second knowledge-graph completion task 722 in the manner specified in FIG. 6, with reference to examples mined from a second knowledge graph 724. Assume that the second knowledge graph 724 incudes a second set of entities connected by a second set of edges.

The second set of entities (in the second knowledge graph 724) differs from the first of entities (in the first knowledge graph 716), and/or the second set of edges (in the second knowledge graph 724) differs from the first set of edges (in the first knowledge graph 716). For instance, the second knowledge graph 724 can include entities that are not present in the first knowledge graph 716, and/or vice versa. Further, the second knowledge graph 724 can include edges that are not included in the first knowledge graph 716, and vice versa. In some cases, the second knowledge graph 724 and the first knowledge graph 716 can be considered separate knowledge domains, although their knowledge may intersect in some ways (although it is not necessary that existing relations link the two domains together). In some cases, the second knowledge graph 724 includes fewer entities compared to the first knowledge graph 716, and the training that the third training subsystem 718 performs is less extensive than the training that the second training subsystem 710 performs.

Although not shown, one or more developers may further refine any version of the encoder model 106, with reference to one or more new knowledge graphs. In other words, a encoder model 106 may represent the outcome of any number of previous training operations performed with respect to any number of knowledge graphs. As pointed out above, the weights produced by the encoder model 106 may be considered universal and extensible insofar as they serve as a framework for refinement with respect to any knowledge domain. As further illustrated above, the knowledge domains need not be aligned.

Consider the following concrete example. Assume that a developer generates a version of the completion engine 104 by training on a knowledge graph that includes facts about sporting teams in the United States. (In some cases, assume that this developer begins training with a model that includes a pre-trained set of weights produced by the first training subsystem 702.) Assume that the developer next fine-tunes the completion engine 104 by training on a knowledge graph that includes facts about the Seattle Seahawks, which is a football team in Seattle, Washington. Assume that the Seattle Seahawks knowledge graph is smaller in scope than the general sports knowledge graph. But the Seattle Seahawks knowledge graph can also be expected to include some entities and edges that are not found in the general sports knowledge graph; indeed, it may also have some clusters of entities and edges that have no existing connection to the general sports knowledge graph. Due to the training system's ability to capture universal knowledge, the training system 108 is able to successfully incorporate the knowledge about the Seattle Mariners.

Two observations apply to the above example. First, the approach shown in FIG. 7 frees a developer from starting from “scratch” when he or she develops an encoder model based on the knowledge graph of the Seattle Seahawks. That is, the developer can successfully refine the encoder model 106 that has been previously trained on the knowledge graph devoted to general sports topics. As noted above, this aspect contributes the scalability of the computing system 102 shown in FIG. 1. Second, the developer can produce a more accurate model by successively refining models in the above-described manner, as opposed to generating a new encoder model from “scratch” based on the knowledge graph for the Seattle Seahawks.

The completion engine 104 is also scalable because it is able to successfully functions in an inductive role, e.g., by determining the identity of target entities that were not previously encountered in any of the training examples previously processed. For example, assume that the developer in the above scenario uses the completion engine 104 to ask a question about the mayor of Seattle, Washington, and that no previous training example mentioned this entity. In some cases, the completion engine 104 successfully predicts the correct target entity based on the second version 712 or the third version 720 of encoder model 106. The completion engine 104 can also incorporate a new fact for the case in which neither the source entity nor the target entity associated with this new fact were encountered in prior training examples. The same inductive ability applies to any use of the completion engine 104 by end users.

Note that the versions (712, 720) of the encoder model 106 produced by the second and third training subsystems (710, 718) produce weights that reflect two goals: the accurate capture of semantic information pertaining to entities and relations in the training examples; and the accurate representation of facts expressed by the training examples. In contrast, the weights produced in the course of training a traditional large language model only represent the linguistic patterns exhibited by a set of training examples.

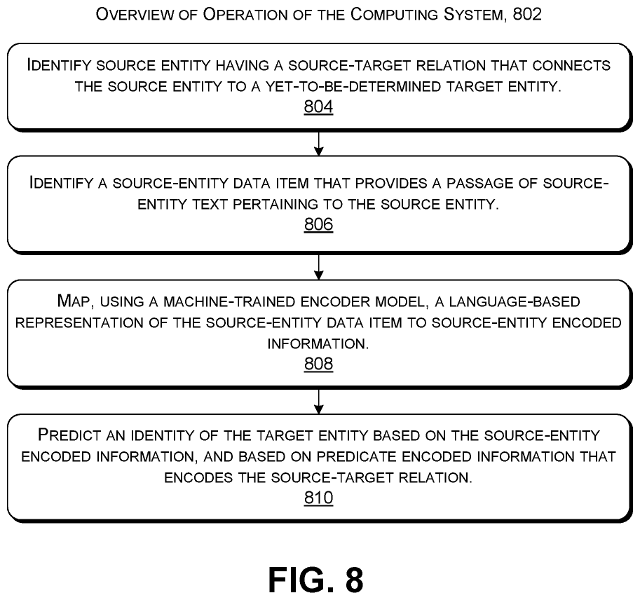

FIG. 8 shows a process 802 for supplementing a knowledge graph (e.g., 110), performed by the computing system 102 of FIG. 1. The following general information applies to all processes described in this Detailed Description, including the process 802. The process 802 is expressed as a series of operations performed in a particular order. But the order of these operations is merely representative, and the operations are capable of being varied in other implementations. Further, any two or more operations described below can be performed in a parallel manner. In one implementation, the blocks shown in the process 802 that pertain to processing-related functions are implemented by the hardware logic circuitry described in connection with FIGS. 11 and 12, which, in turn, is implemented by one or more processors, a computer-readable storage medium, etc.

In block 804, the computing system 102 identifies a source entity having a source-target relation that connects the source entity to a yet-to-be-determined target entity. In block 806, the computing system 102 identifies a source-entity data item that provides a passage of source-entity text pertaining to the source entity. In block 808, the computing system 102 maps, using a machine-trained encoder model (e.g., 106), a language-based representation of the source-entity data item to source-entity encoded information. In block 810, the computing system 102 predicts an identity of the target entity based on the source-entity encoded information, and based on predicate encoded information that encodes the source-target relation.

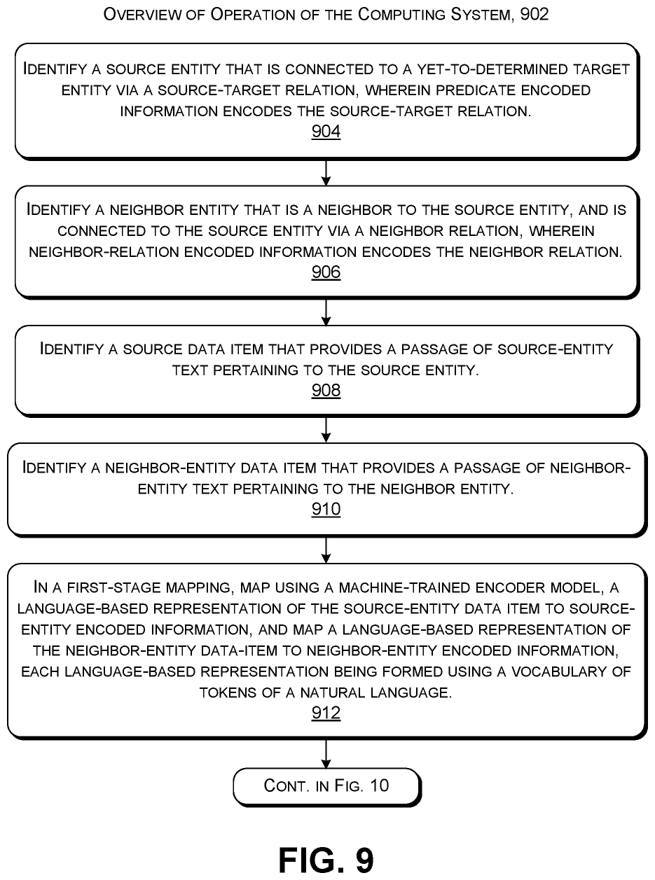

FIGS. 9 and 10 show another process 902 for supplementing a knowledge graph (e.g., 110), performed by the computing system 102 of FIG. 1. In block 904, the computing system 102 identifies a source entity that is connected to a yet-to-determined target entity via a source-target relation, wherein predicate encoded information encodes the source-target relation. In block 906, the computing system 102 identifies a neighbor entity that is a neighbor to the source entity, and is connected to the source entity via a neighbor relation, wherein neighbor-relation encoded information encodes the neighbor relation. In block 908, the computing system 102 identifies a source data item that provides a passage of source-entity text pertaining to the source entity. In block 910, the computing system 102 identifies a neighbor-entity data item that provides a passage of neighbor-entity text pertaining to the neighbor entity.

In block 912, in a first-stage mapping, the computing system 102 maps using a machine-trained encoder model, a language-based representation of the source-entity data item to source-entity encoded information, and maps a language-based representation of the neighbor-entity data-item to neighbor-entity encoded information, each language-based representation being formed using a vocabulary of tokens of a natural language. In block 1002 of FIG. 10, in a second-stage mapping, the computing system 102 maps the source-entity encoded information, the neighbor-entity encoded information, the neighbor-relation encoded information, and the predicate encoded information to neighbor-aware source-entity information. In block 1004, the computing system 102 predicts an identity of the target entity based on the neighbor-aware source-entity information.

FIG. 11 shows computing equipment 1102 that, in some implementations, is used to implement the computing system 102 of FIG. 1. The computing equipment 1102 includes a set of user devices 1104 coupled to a set of servers 1106 via a computer network 1108. Each user device corresponds to any type of computing device, including any of a desktop computing device, a laptop computing device, a handheld computing device of any type (e.g., a smartphone or a tablet-type computing device), a mixed reality device, an intelligent appliance, a wearable computing device (e.g., a smart watch), an Internet-of-Things (IoT) device, a gaming system, an immersive “cave,” a media device, a vehicle-borne computing system, any type of robot computing system, a computing system in a manufacturing system, etc. In some implementations, the computer network 1108 is implemented as a local area network, a wide area network (e.g., the Internet), one or more point-to-point links, or any combination thereof.

The dashed-line box in FIG. 11 indicates that the functionality of the computing system 102 is capable of being spread across the user devices 1104 and/or the servers 1106 in any manner. For instance, in some cases, each user commuting device, or a group of affiliated user computing devices, implements the entirety the computing system 102. In other cases, the servers 1116 implement the entirety of the computing system 102; here, a developer or user may interact with the servers 106 via a browser application provided by a local device. In other cases, the functionality of the computing system 102 is shared between each user device and the servers 1106.

FIG. 12 shows a computing system 1202 that, in some implementations, is used to implement any aspect of the mechanisms set forth in the above-described figures. For instance, in some implementations, the type of computing system 1202 shown in FIG. 12 is used to implement any local computing device or any server shown in FIG. 11. In all cases, the computing system 1202 represents a physical and tangible processing mechanism.

The computing system 1202 includes a processing system 1204 including one or more processors. The processor(s) include one or more Central Processing Units (CPUs), and/or one or more Graphics Processing Units (GPUs), and/or one or more Application Specific Integrated Circuits (ASICs), and/or one or more Neural Processing Units (NPUs), etc. More generally, any processor corresponds to a general-purpose processing unit or an application-specific processor unit.

The computing system 1202 also includes computer-readable media 1206, corresponding to one or more computer-readable media hardware units. The computer-readable media 1206 retains any kind of information 1208, such as machine-readable instructions, settings, model weights, and/or other data. In some implementations, the computer-readable media 1206 includes one or more solid-state devices, one or more magnetic hard disks, one or more optical disks, magnetic tape, etc. Any instance of the computer-readable media 1206 uses any technology for storing and retrieving information. Further, any instance of the computer-readable media 1206 represents a fixed or removable unit of the computing system 1202. Further, any instance of the computer-readable media 1206 provides volatile and/or non-volatile retention of information.

More generally, any of the storage resources described herein, or any combination of the storage resources, is to be regarded as a computer-readable medium. In many cases, a computer-readable medium represents some form of physical and tangible entity. The term computer-readable medium also encompasses propagated signals, e.g., transmitted or received via a physical conduit and/or air or other wireless medium. However, the specific term “computer-readable storage medium” or “storage device” expressly excludes propagated signals per se in transit, while including all other forms of computer-readable media; a computer-readable storage medium or storage device is “non-transitory” in this regard.

The computing system 1202 utilizes any instance of the computer-readable storage media 1206 in different ways. For example, in some implementations, any instance of the computer-readable storage media 1206 represents a hardware memory unit (such as random access memory (RAM)) for storing information during execution of a program by the computing system 1202, and/or a hardware storage unit (such as a hard disk) for retaining/archiving information on a more permanent basis. In the latter case, the computing system 1202 also includes one or more drive mechanisms 1210 (such as a hard drive mechanism) for storing and retrieving information from an instance of the computer-readable storage media 1206.

In some implementations, the computing system 1202 performs any of the functions described above when the processing system 1204 executes computer-readable instructions stored in any instance of the computer-readable storage media 1206. For instance, in some implementations, the computing system 1202 carries out computer-readable instructions to perform each block of the processes described in with reference to FIGS. 8 and 9. FIG. 12 generally indicates that hardware logic circuitry 1212 includes any combination of the processing system 1204 and the computer-readable storage media 1206.

In addition, or alternatively, the processing system 1204 includes one or more other configurable logic units that perform operations using a collection of logic gates. For instance, in some implementations, the processing system 1204 includes a fixed configuration of hardware logic gates, e.g., that are created and set at the time of manufacture, and thereafter unalterable. In addition, or alternatively, the processing system 1204 includes a collection of programmable hardware logic gates that are set to perform different application-specific tasks. The latter category of devices includes Programmable Array Logic Devices (PALs), Generic Array Logic Devices (GALs), Complex Programmable Logic Devices (CPLDs), Field-Programmable Gate Arrays (FPGAs), etc. In these implementations, the processing system 1204 effectively incorporates a storage device that stores computer-readable instructions, insofar as the configurable logic units are configured to execute the instructions and therefore embody or store these instructions.

In some cases (e.g., in the case in which the computing system 1202 represents a user computing device), the computing system 1202 also includes an input/output interface 1214 for receiving various inputs (via input devices 1216), and for providing various outputs (via output devices 1218). Illustrative input devices include a keyboard device, a mouse input device, a touchscreen input device, a digitizing pad, one or more static image cameras, one or more video cameras, one or more depth camera systems, one or more microphones, a voice recognition mechanism, any position-determining devices (e.g., GPS devices), any movement detection mechanisms (e.g., accelerometers and/or gyroscopes), etc. In some implementations, one particular output mechanism includes a display device 1220 and an associated graphical user interface presentation (GUI) 1222. The display device 1220 corresponds to a liquid crystal display device, a light-emitting diode display (LED) device, a cathode ray tube device, a projection mechanism, etc. Other output devices include a printer, one or more speakers, a haptic output mechanism, an archival mechanism (for storing output information), etc. In some implementations, the computing system 1202 also includes one or more network interfaces 1224 for exchanging data with other devices via one or more communication conduits 1226. One or more communication buses 1228 communicatively couple the above-described units together.

The communication conduit(s) 1226 is capable of being implemented in any manner, e.g., by a local area computer network, a wide area computer network (e.g., the Internet), point-to-point connections, or any combination thereof. The communication conduit(s) 1226 include any combination of hardwired links, wireless links, routers, gateway functionality, name servers, etc., governed by any protocol or combination of protocols.

FIG. 12 shows the computing system 1202 as being composed of a discrete collection of separate units. In some cases, the collection of units corresponds to discrete hardware units provided in a computing device chassis having any form factor. FIG. 12 shows illustrative form factors in its bottom portion. In other cases, the computing system 1202 includes a hardware logic unit that integrates the functions of two or more of the units shown in FIG. 1. For instance, in some implementations, the computing system 1202 includes a system on a chip (SoC or SOC), corresponding to an integrated circuit that combines the functions of two or more of the units shown in FIG. 12.

The following summary provides a set of illustrative examples of the technology set forth herein.

(A1) According to a first aspect, a computer-implemented method (e.g., 802) is described for supplementing a knowledge graph (e.g., 110). The method includes: identifying (e.g., in block 804) a source entity having a source-target relation that connects the source entity to a yet-to-be-determined target entity; identifying (e.g., in block 806) a source-entity data item that provides a passage of source-entity text pertaining to the source entity; mapping (e.g., in block 808), using a machine-trained encoder model (e.g., 106), a language-based representation of the source-entity data item to source-entity encoded information; and predicting (e.g., in block 810) an identity of the target entity based on the source-entity encoded information, and based on predicate encoded information that encodes the source-target relation.

(A2) According to some implementations of the method of A1, at least the target entity is not yet represented by the knowledge graph, and the computer-implemented method further includes adding a node associated with the target entity to the knowledge graph.

(A3) According to some implementations of the methods of A1 or A2, the target entity is represented by the knowledge graph, and the computer-implemented method is performed in a course of training the machine-trained encoder model.

(A4) According to some implementations of any individual method of the methods of A1-A3, the machine-trained encoder model is trained in a training operation. At a start of the training operation, the machine-trained encoder model includes a set weights that are trained with respect to a language-modeling task.

(A5) According to some implementations of any individual method of the methods of A1-A3, the knowledge graph is a first knowledge graph, and the machine-trained encoder model is trained in a first training operation using the first knowledge graph. Further, at a start of the first training operation, the machine-trained encoder model includes a set weights that are trained with respect to a second training operation that precedes the first training operation, and which uses a second knowledge graph. The second knowledge graph is different than the first knowledge graph.

(A6) According to some implementations of the method of A5, a set of entities associated with the first knowledge graph differs from a set of entities associated with the second knowledge graph, and/or a set of relations associated with the first knowledge graph differs from a set of relations associated with the second knowledge graph.

(A7) According to some implementations of the method of A5, at a start of the second training operation, the machine-trained encoder model includes a set weights that are trained with respect to a language-modeling task.

(A8) According to some implementations of any individual method of the methods of A1-A7, the method further includes: identifying a neighbor entity that is a neighbor to the source entity, and is connected to the source entity via a neighbor relation; and identifying a neighbor-entity data item that provides a passage of neighbor-entity text pertaining to the neighbor entity.

(A9) According to some implementations of the method of A8, the mapping includes: in a first-stage mapping, in addition to producing the source-entity encoded information, using the machine-trained encoder model to map a language-based representation of the neighbor-entity data item to neighbor-entity encoded information; and, in a second-stage mapping, mapping the source-entity encoded information, the neighbor-entity encoded information, and the predicate encoded information to neighbor-aware source-entity information. The predicting includes predicting the identity of the target entity based on the neighbor-aware source-entity information.

(A10) According to some implementations of the method of A9, the second-stage mapping also operates on neighbor-relation encoded information, the neighbor-relation encoded information being produced by encoding the neighbor relation.

(A11) According to some implementations of the method of A9, the first-stage mapping involves mapping plural neighbor-entity data items to plural instances of neighbor-entity encoded information, and the second-stage mapping uses the plural instances of neighbor-entity encoded information to produce the neighbor-aware source-entity information.

(A12) According to some implementations of any individual method of the methods of A1-A11, the machine-trained encoder model uses attention-based logic that interprets input information fed to the attention-based logic by considering relations among different parts of the input information.

(A13) According to some implementations of any individual method of the methods of A1-A11, the machine-trained encoder model is a transformer-based neural network.

In yet another aspect, some implementations of the technology described herein include a computing system (e.g., the computing system 1202) that includes a processing system (e.g., the processing system 1204). The computing system also includes a storage device (e.g., the computer-readable storage media 1206) for storing computer-readable instructions (e.g., information 1208). The processing system executes the computer-readable instructions to perform any of the methods described herein (e.g., any individual method of the methods of A1-A13).

In yet another aspect, some implementations of the technology described herein include a computer-readable storage medium (e.g., the computer-readable storage media 1206) for storing computer-readable instructions (e.g., the information 1208). A processing system (e.g., the processing system 1204) executes the computer-readable instructions to perform any of the operations described herein (e.g., the operation in any individual method of the methods of A1-A13).

More generally stated, any of the individual elements and steps described herein are combinable into any logically consistent permutation or subset. Further, any such combination is capable of being be manifested as a method, device, system, computer-readable storage medium, data structure, article of manufacture, graphical user interface presentation, etc. The technology is also expressible as a series of means-plus-format elements in the claims, although this format should not be considered to be invoked unless the phrase “means for” is explicitly used in the claims.

As to terminology used in this description, the phrase “configured to” encompasses various physical and tangible mechanisms for performing an identified operation. The mechanisms are configurable to perform an operation using the hardware logic circuitry 1212 of FIG. 12. The term “logic” likewise encompasses various physical and tangible mechanisms for performing a task. For instance, each processing-related operation illustrated in the flowcharts of FIGS. 7-9 corresponds to a logic component for performing that operation.

This description may have identified one or more features as optional. This type of statement is not to be interpreted as an exhaustive indication of features that are to be considered optional; generally, any feature is to be considered as optional, although not explicitly identified in the text, unless otherwise noted. Further, any mention of a single entity is not intended to preclude the use of plural such entities; similarly, a description of plural entities in the specification is not intended to preclude the use of a single entity. As such, a statement that an apparatus or method has a feature X does not preclude the possibility that it has additional features. Further, any features described as alternative ways of carrying out identified functions or implementing identified mechanisms are also combinable together in any combination, unless otherwise noted.

In terms of specific terminology, the term “plurality” or “plural” or the plural form of any term (without explicit use of “plurality” or “plural”) refers to two or more items, and does not necessarily imply “all” items of a particular kind, unless otherwise explicitly specified. The term “at least one of” refers to one or more items; reference to a single item, without explicit recitation of “at least one of” or the like, is not intended to preclude the inclusion of plural items, unless otherwise noted. Further, the descriptors “first,” “second,” “third,” etc. are used to distinguish among different items, and do not imply an ordering among items, unless otherwise noted. The phrase “A and/or B” means A, or B, or A and B. The phrase “any combination thereof” refers to any combination of two or more elements in a list of elements. Further, the terms “comprising,” “including,” and “having” are open-ended terms that are used to identify at least one part of a larger whole, but not necessarily all parts of the whole. A “set” includes zero members, one member, or more than one member. Finally, the terms “exemplary” or “illustrative” refer to one implementation among potentially many implementations.

In closing, the functionality described herein is capable of employing various mechanisms to ensure that any user data is handled in a manner that conforms to applicable laws, social norms, and the expectations and preferences of individual users. For example, the functionality is configurable to allow a user to expressly opt in to (and then expressly opt out of) the provisions of the functionality. The functionality is also configurable to provide suitable security mechanisms to ensure the privacy of the user data (such as data-sanitizing mechanisms, encryption mechanisms, and/or password-protection mechanisms).

Further, the description may have set forth various concepts in the context of illustrative challenges or problems. This manner of explanation is not intended to suggest that others have appreciated and/or articulated the challenges or problems in the manner specified herein. Further, this manner of explanation is not intended to suggest that the subject matter recited in the claims is limited to solving the identified challenges or problems; that is, the subject matter in the claims may be applied in the context of challenges or problems other than those described herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method for supplementing a knowledge graph, comprising:
identifying a source entity having a source-target relation that connects the source entity to a yet-to-be-determined target entity;
identifying a source-entity data item that provides a passage of source-entity text pertaining to the source entity;
mapping, using a machine-trained encoder model, a language-based representation of the source-entity data item to source-entity encoded information; and
predicting an identity of the target entity based on the source-entity encoded information, and based on predicate encoded information that encodes the source-target relation.

2. The computer-implemented method of claim 1, wherein at least the target entity is not yet represented by the knowledge graph, and wherein the computer-implemented method further includes adding a node associated with the target entity to the knowledge graph.

3. The computer-implemented method of claim 1, wherein the target entity is represented by the knowledge graph, and wherein the computer-implemented method is performed in a course of training the machine-trained encoder model.

4. The computer-implemented method of claim 1,
wherein the machine-trained encoder model is trained in a training operation, and
wherein at a start of the training operation, the machine-trained encoder model includes a set weights that are trained with respect to a language-modeling task.

5. The computer-implemented method of claim 1,
wherein the knowledge graph is a first knowledge graph,
wherein the machine-trained encoder model is trained in a first training operation using the first knowledge graph, and
wherein at a start of the first training operation, the machine-trained encoder model includes a set weights that are trained with respect to a second training operation that precedes the first training operation, and which uses a second knowledge graph,
the second knowledge graph being different than the first knowledge graph.

6. The computer-implemented method of claim 5,
wherein a set of entities associated with the first knowledge graph differs from a set of entities associated with the second knowledge graph, and/or
wherein a set of relations associated with the first knowledge graph differs from a set of relations associated with the second knowledge graph.

7. The computer-implemented method of claim 5, wherein at a start of the second training operation, the machine-trained encoder model includes a set weights that are trained with respect to a language-modeling task.

8. The computer-implemented method of claim 1, further comprising:
identifying a neighbor entity that is a neighbor to the source entity, and is connected to the source entity via a neighbor relation; and
identifying a neighbor-entity data item that provides a passage of neighbor-entity text pertaining to the neighbor entity.

9. The computer-implemented method of claim 8, wherein the mapping includes:
in a first-stage mapping, in addition to producing the source-entity encoded information, using the machine-trained encoder model to map a language-based representation of the neighbor-entity data item to neighbor-entity encoded information; and
in a second-stage mapping, mapping the source-entity encoded information, the neighbor-entity encoded information, and the predicate encoded information to neighbor-aware source-entity information,
wherein the predicting includes predicting the identity of the target entity based on the neighbor-aware source-entity information.

10. The computer-implemented method of claim 9, wherein the second-stage mapping also operates on neighbor-relation encoded information, the neighbor-relation encoded information being produced by encoding the neighbor relation.

11. The computer-implemented method of claim 9, wherein the first-stage mapping involves mapping plural neighbor-entity data items to plural instances of neighbor-entity encoded information, and wherein the second-stage mapping uses the plural instances of neighbor-entity encoded information to produce the neighbor-aware source-entity information.

12. The computer-implemented method of claim 1, wherein the machine-trained encoder model uses attention-based logic that interprets input information fed to the attention-based logic by considering relations among different parts of the input information.

13. The computer-implemented method of claim 1, wherein the machine-trained encoder model is a transformer-based neural network.

14. A computing system for providing content, comprising:
a store for storing computer-readable instructions;
a store for storing a knowledge graph;
a processing system for executing the computer-readable instructions to perform operations that include:
identifying a source entity having a source-target relation that connects the source entity to a yet-to-be-determined target entity via a source-target relation;
identifying a source-entity data item that provides a passage of source-entity text pertaining to the source entity;
mapping, using a machine-trained encoder model, a language-based representation of the source-entity data item to source-entity encoded information; and
predicting an identity of the target entity based on the source-entity encoded information, and based on predicate encoded information that encodes the source-target relation.

15. The computing system of claim 14, wherein the knowledge graph is a first knowledge graph,
wherein the machine-trained encoder model is trained in a first training operation using the first knowledge graph,
wherein at a start of the first training operation, the machine-trained encoder model includes a set weights that are trained with respect to a second training operation that precedes the first training operation, and which uses a second knowledge graph, and
wherein a set of entities associated with the first knowledge graph differs from a set of entities associated with the second knowledge graph, and/or wherein a set of relations associated with the first knowledge graph differs from a set of relations associated with the second knowledge graph.

16. The computing system of claim 15, wherein at a start of the second training operation, the machine-trained encoder model includes a set weights that are trained with respect to a language-modeling task.

17. The computing system of claim 14, wherein the operations further comprise:
identifying a neighbor entity that is a neighbor to the source entity, and is connected to the source entity via a neighbor relation, wherein neighbor-relation encoded information encodes the neighbor relation; and
identifying a neighbor-entity data item that provides a passage of neighbor-entity text pertaining to the neighbor entity,
wherein the mapping includes:
in first-stage mapping, in addition to producing the source-entity encoded information, using to the machine-trained encoder model to map a language-based representation of the neighbor-entity data item to neighbor-entity encoded information; and
in second-stage mapping, mapping the source-entity encoded information, the neighbor-entity encoded information, the neighbor-relation encoded information, and the predicate encoded information to neighbor-aware source-entity information,
wherein the predicting includes predicting the identity of the target entity based on the neighbor-aware source-entity information.

18. A computer-readable storage medium for storing computer-readable instructions, a processing system executing the computer-readable instructions to perform operations, the operations comprising:
identifying a source entity that is connected to a yet-to-determined target entity via a source-target relation, wherein predicate encoded information encodes the source-target relation;
identifying a neighbor entity that is a neighbor to the source entity, and is connected to the source entity via a neighbor relation, wherein neighbor-relation encoded information encodes the neighbor relation;
identifying a source data item that provides a passage of source-entity text pertaining to the source entity;
identifying a neighbor-entity data item that provides a passage of neighbor-entity text pertaining to the neighbor entity,
in a first-stage mapping, mapping using a machine-trained encoder model, a language-based representation of the source-entity data item to source-entity encoded information, and mapping a language-based representation of the neighbor-entity data-item to neighbor-entity encoded information, each language-based representation being formed using a vocabulary of tokens of a natural language;
in second-stage mapping, mapping the source-entity encoded information, the neighbor-entity encoded information, the neighbor-relation encoded information, and the predicate encoded information to neighbor-aware source-entity information; and
predicting an identity of the target entity based on the neighbor-aware source-entity information.

19. The computer-readable storage medium of claim 18,
wherein the knowledge graph is a first knowledge graph,
wherein the machine-trained encoder model is trained in a first training operation using the first knowledge graph,
wherein at a start of the first training operation, the machine-trained encoder model includes a set weights that are trained with respect to a second training operation that precedes the first training operation, and which uses a second knowledge graph, and
wherein a set of entities associated with the first knowledge graph differs from a set of entities associated with the second knowledge graph, and/or a set of relations associated with the first knowledge graph differs from a set of relations associated with the second knowledge graph.

20. The computer-readable storage medium of claim 19, wherein at a start of the second training operation, the machine-trained encoder model includes a set weights that are trained with respect to a language-modeling task.
